(19) United States
(12) Patent Application Publication
(10) Pub. No.: US 2023/0072098 A1
(43) Pub. Date: Mar. 9, 2023

(54) PRESERVATIVE FREE SHELF STABLE LIQUID FLAVORED CONCENTRATE

(71) Applicant: Aly Gamay, McLean, VA (US)

(72) Inventor: Aly Gamay, McLean, VA (US)

(73) Assignee: DreamPak, LLC, McLean, VA (US)

(21) Appl. No.: 18/054,894

(22) Filed: Nov. 12, 2022

Related U.S. Application Data
(63) Continuation-in-part of application No. 17/326,292, filed on May 20, 2021.
(60) Provisional application No. 63/050,710, filed on Jul. 10, 2020.

(51) Int. Cl. A23L 2/68; A23L 2/385; A23L 2/56; A23L 2/44

(52) U.S. Cl. CPC A23L 2/68; A23L 2/385; A23L 2/56; A23L 2/44; A23V 2002/00

(57) ABSTRACT

The disclosed subject matter provides preservative-free liquid flavored beverage concentrate compositions, food package kits comprising such compositions, and methods of preparing such compositions and kits.

### CROSS-REFERENCE TO RELATED APPLICATIONS

This application is a continuation-in-part of co-pending U.S. patent application Ser. No. 17/326,292, filed May 20, 2021, which claims the benefit of U.S. Provisional Application No. 63/050,710, filed Jul. 10, 2020. The entire disclosure of the prior applications is hereby incorporated by reference.

### FIELD OF INVENTION

Disclosed are shelf-stable liquid flavored beverage concentrate compositions comprising lactic acid as an acidulant and antimicrobial agent, kits comprising such compositions, and methods of preparing such compositions and kits.

### BACKGROUND

Current trends for consumer beverages recognize the importance of eliminating bulky water to save energy, reduce shipping costs and release storage space both in retail channels and at home. The flavored beverage industry is a multibillion-dollar industry looking for convenience, nutrition, portability, and invigorating flavors. However, the distribution and storage of such beverages are cumbersome. There is a need for a point-of-consumption flavored concentrated composition that works as a liquid water enhancer in small bottles to improve portability and storage and deliver nutritional benefits without any addition of preservatives or artificial chemicals.

One drawback of flavored concentrates in the market is the overly sour taste which may turn off consumers. To deliver a strong background taste, current products in the market rely on high inclusion levels of strong acids like citric acid and malic acid, which impart harshness and astringency to the diluted product and require the presence of buffering agents. Another drawback of current flavored concentrates is that they contain artificial preservatives, which do not appeal to health-conscious consumers.

The present invention provides flavored concentrates with a mild acidic background taste identifiable with naturally occurring fresh fruit flavors, without acid bite, unpleasant sourness, or incorporation of artificial preservatives.

The present invention also provides improved methods using all-liquid ingredients to produce beverage concentrates and ultra-concentrated shelf-stable flavored concentrates and kits comprising such concentrates.

### SUMMARY

The present invention provides shelf-stable, flavored, concentrated compositions that are useful for preparing beverages with enhanced organoleptic profiles and do not require artificial preservatives, as well as methods of preparing such compositions.

In some embodiments, the shelf-stable, flavored, concentrated compositions mimic the flavor profile of natural fruits.

In some embodiments, the shelf-stable, flavored, concentrated compositions lack any off-putting astringency associated with acids such as citric acid and malic acid.

In some embodiments, the shelf-stable, flavored, concentrated compositions comprise exclusively of liquid components for ease and speed of blending during manufacturing.

In some embodiments, the shelf-stable, flavored, concentrated compositions provide superior taste, nutritional benefits, portability, and/or shelf life compared to commercial concentrates.

In some embodiments, the shelf-stable, flavored concentrated composition does not require the presence of buffering agents.

In some embodiments, the shelf-stable, flavored, concentrated compositions eliminate the need to add any preservatives that exist in commercial concentrates.

Other features and advantages of the present invention will be apparent from this summary and the following description, examples, embodiments, and claims to those skilled in the relevant art.

### Definitions

Unless defined otherwise, all technical and scientific terms herein have the same meaning as commonly understood by one of ordinary skill in the art to which this invention belongs. Still, certain elements are defined below for clarity and ease of reference.

“Shelf-stable” means a food product that is microbiologically and chemically stable at ambient temperature (e.g., without the food product substantially breaking down by, for instance, microbial contamination, syneresis, or water accumulation) without refrigeration or freezing for twelve months.

“Ambient” refers to a temperature in the range of about 65° F. to about 85° F.

The term “pH” is used to designate the intensity or degree of acidity. The value of pH, the logarithm of the reciprocal of the hydrogen ion concentration in solution, is usually determined by measuring the difference potential between two electrodes immersed in a sample solution.

The term “water activity level” is defined in the book “Food Science”, Third Edition, A.V.I. (1984) as a qualitative measure of unbound free water in a system that is available to support biological and chemical reactions. In general, as the water activity of a given food product decreases, its shelf life increases. A high-water activity (_{AW}) product becomes more susceptible to mold, fungus, and bacterial proliferation. For instance, the FDA defines a low acid food product with a pH of greater than 4.6 as shelf-stable only if it has a water activity of 0.85 or less. Two foods with the same water content can vary significantly in their water activity depending on how much free water is in the system. When a food is in moisture equilibrium with its environment, the water activity of the food will be quantitatively equal to the relative humidity in the container's headspace divided by 100.

Percentages (%) of ingredients of the compositions are expressed as a weight unit of ingredients in a total of 100 weight units of the concentrate.

While the numerical parameters setting forth the scope of the disclosed subject matter are approximations, the numerical values set forth in the working examples are reported as precisely as possible. However, any numerical value inherently contains certain errors necessarily resulting from the standard deviation found in its respective testing measurements.

### DETAILED DESCRIPTION

Throughout the specification and claims, percentages are by weight and temperatures in degrees Fahrenheit unless otherwise indicated.

Flavored Beverage Concentrate Compositions

One aspect of the present invention relates to a shelf-stable liquid beverage concentrate compositions. The compositions uniquely employ lactic acid to impart pleasant acidic notes and enhance the fruit perception of the final beverages.

Unlike prior art technology, the inventive compositions do not require any buffering agent to balance out the negative impact of using harsh acids. The inventive compositions differ from previously developed commercial concentrates in their use of lactic acid. Instead of lactic acid, previous fruit flavored concentrates include acids like citric acid and malic acid that naturally exist in fruit and impart an astringent taste when used at elevated levels, thus requiring the use of buffering agents to offset the astringent taste.

Many liquid concentrates in the market include buffers. The inclusion of buffers allows for increased acid content compared to otherwise identical concentrates without buffers. The present invention eliminates or reduces the need for buffers through the careful selection of mild acids such as lactic acid. While buffers may also be used to regulate pH or modify flavor profiles, the inventive compositions deliver a pleasant taste even at much lower pH ranges in the absence of buffers. Nonetheless, the inventive compositions may incorporate various levels of buffers if desired to impart different flavor profiles.

Previous beverage concentrates have incorporated acid combinations for their antimicrobial effect. Nevertheless, finding a balance between the high acidity for microbial inhibition and the optimum acidity for a desirable beverage flavor have proven elusive. Hence, buffering agents are included in prior formulations.

The inventive compositions include carefully selected ingredients at varying proportions depending on the final products' desired characteristics. In some embodiments, the inventive compositions comprise lactic acid, flavoring, water, and optional ingredients.

Consumer perception that synthetic food additives may be associated with potential toxicological problems has recently generated interest in the use of naturally derived compounds in the food industry. The use of lactic acid is considered a good alternative. It may be more acceptable to consumers than synthetic food additives because of its natural origin, potential antimicrobial activity, and function as a preservative, antioxidant, flavoring, and acidifying agent. Lactic acid is one of the earliest antibacterial substances to be harnessed by humankind. The first examples of functional chemistry in history include the fermentation of food. The most ancient example is the use of fermented milk products. For centuries people have applied the same process using lactic acid bacteria to preserve vegetables, sausages, cheese, and silage feed for animals. Lactic acid bacteria ferment and acidify these foodstuffs and produce lactic acid. In fermentation, lactic acid is the endpoint of their energy metabolism. Lactic acid is excreted to levels that inhibit competing bacteria, which happen to be undesirable types for humans.

Lactic acid is found primarily in sour milk products, such as yogurt and cheeses. The casein in milk is coagulated (curdled) by lactic acid. Lactic acid is also responsible for the sour flavor of sourdough bread. Some beers purposely contain lactic acid. In winemaking, a bacterial process, natural or controlled, is often used to convert the naturally present malic acid to lactic acid, to reduce the sharpness and for other flavor-related reasons. Lactic acid is normally not found in any significant amount in fruit, and that is the reason formulators of fruit beverage concentrates do not consider it complementary to fruit flavors. The inventor of the present invention discovered the benefits of utilizing lactic acid to replace other acids naturally occurring in fruits.

Lactic acid, i.e., 2-hydroxypropionic acid, is an organic acid with the molecular formula CH₃CH(OH)COOH. It is miscible with water. While in a liquid state, it is a colorless solution. Production of lactic acid includes both artificial and natural syntheses. For example, it can be produced by a microbial fermentation, wherein microorganisms convert a substrate containing carbohydrates (such as glucose) into lactic acid. Lactic acid may be classified into optical isomers of (L)-isomer and (D)-isomer based on the orientation of the hydroxyl group. Microbial fermentation can selectively produce (L)-isomers or (D)-isomers, or a racemic mixture (equal amounts of (L)-isomers and (D)-isomers), of lactic acid by choosing a suitable microorganism. Lactic acid is one of the most widely distributed acids and preservatives in nature. Food-grade lactic acid can be produced by controlled fermentation of refined sucrose or other carbohydrate sources. The compound can be purified by conversion to crystalline calcium lactate, treatment with sulfuric acid, filtration, and evaporation to yield food-grade lactic acid. Lactic acid can also be manufactured synthetically by hydrolysis of lactonitrile. A major advantage of lactic acid is that it is generally recognized as a safe (GRAS) additive according to the U.S. Food and Drug Administration.

The food industry uses different bacteria, in the form of ferments, also referred to as starter cultures, including lactic acid bacteria, to improve the taste and the texture of foods and to extend their shelf life. In the dairy industry, lactic acid bacteria are used extensively to acidify milk (by fermentation) and to give texture and flavor to the product into which they are incorporated. There are many lactic acid bacteria used in the food industry, including the genera Streptococcus and Lactobacillus. The lactic acid bacteria species Streptococcus thermophilus and Lactobacillus delbrueckii spp bulgaricus are used for the formulation of ferments used to produce fermented dairy products, typically fermented milks such as yogurt. Natural L (+) lactic acid is used in various food products, such as dairy products, meat, meat products, beer, bakery products, mayonnaise, dressings, and pickles. As a food acidulant, its main functions are flavoring and preservation. Reasons for selecting lactic acid as a food acidulant include: its mildly acidic taste which leads to flavor enhancement; its preserving properties (lactic acid inhibits the growth of many microorganisms); its natural occurrence in many foodstuffs; and its availability in liquid form.

Lactic acid is a safe, biobased, and biodegradable option for antimicrobial products and formulations, with proven broad range efficacy against bacteria. L-lactic acid is an organic acid and shares several features with similarly sized acids. The unique combination of its low acid dissociation constant (pKa) and low hydrophobicity makes it readily miscible with water. L-lactic acid resides primarily in the water phase of an emulsion. This gives it an advantage over more hydrophobic organic acids like citric acid and malic acid because the water phase is where bacteria also reside. It is particularly effective at shuttling protons across cell membranes. In doing so, it does rely on the low pH of the environment or medium. Once inside the cell, there are four broad-acting mechanisms that inhibit the bacterial cell. Firstly, acid stress disrupts cell regulation on a general level. Secondly, bacteria spend energy to maintain pH by pumping out acid. Thirdly, bacteria change their metabolism to produce alkaline metabolites. Lastly, stress generates free radicals that damage all cellular mechanisms. Bacteria exposed to lactic acid cannot respond by adapting their structure or metabolism for survival. The sudden severe acid stress leads to an unmitigated shock of oxidative stress, while any survival mechanisms are suppressed by the low intracellular pH. No single adaptation could render a bacterium resistant. The generation of oxidative stress occurs at the cell membrane due to the malfunctioning of the electron transport chain. Furthermore, lactic acid exhibits antiviral activity.

Lactic acid is effective against gram-negative bacteria in the absence of surfactants. Gram-positive bacteria are generally less sensitive to lactic acid but are rendered susceptible by surfactants. Surfactants may be added to the inventive compositions to enhance lactic acid's effect on gram-positive bacteria; however, at the high concentrations used in the inventive compositions, e.g., up to 70% of the concentrate, the potency of lactic acid against all bacterial, viral, and mycotic strains is ensured.

Lactic acid suppresses the growth of many microorganisms like B. cereus, B. subtilis, B. megaterium, B. circulans, Serratia liquefaciens, Yersinia enterocolitica, Enterobacter cloacae and Aeromonas hydrophila, Clostridium botulinum, Listeria monocytogenes, Escherichia coli, Proteus mirabilis, Salmonella enteritidis, Pseudomonas aeruginosa, Staphylococcus aureus, Enterococcus faecalis as well as yeasts like Rhodotorula sp., Saccharomyces cerevisiae and Candida albicans. Lactic acid could be used as an efficient natural antimicrobial agent to improve the safety of all-natural foods.

Sodium lactate and lactic acid have been determined to be safe for use in foods and are listed as additives generally recognized as safe (GRAS) by the Food and Drug Administration.

In some embodiments, the inventive composition has been microbiologically stabilized by lactic acid, which exhibits higher antimicrobial activity than other acids used in the beverage industry, thus eliminating the need for preservative inclusion and providing clean-label products.

In some embodiments of the inventive composition, the lactic acid comprises about 10% to about 90% by weight water. In further embodiments, the lactic acid comprises about 88% by weight water.

Selection of the acidulant used in various embodiments of the beverage concentrates described herein can provide substantially improved flavor and reduced aftertaste, even when the concentrate is added to water at greater than typical amounts of concentrate. In some embodiments, the acidulant comprises about 100% by weight lactic acid. In other embodiments, the acidulant further comprises citric acid, malic acid, and/or phosphoric acid, singularly or in combination, at about 10% to about 55% by weight, with lactic acid constituting the remainder of the acid blend.

It was surprising to discover that lactic acid could be used solely to mimic so many acids that naturally occur in various fruits. For example, malic acid is the predominant, naturally occurring acid in watermelon. It was found that the inclusion of lactic acid in a watermelon-flavored beverage concentrate provided a significantly improved taste compared to a similar beverage concentrate containing malic acid. Lactic acid inclusion can mimic other fruits, including blackberry, cherry, apple, peach, nectarine, lychee, quince, and pear, where malic acid is the predominant, naturally occurring acid.

It was similarly surprising to find that lactic acid could mimic the flavor of fruits where citric acid is the predominant, naturally occurring acid—for example, citrus fruits (e.g., lemon, lime, orange), strawberry, and pineapple—and that using lactic acid in flavored concentrates with these flavor profiles provided significantly improved taste compared to similar beverages made with citric acid.

The pH can be established using any combination of food-grade acid, such as but not limited to citric acid, malic acid, succinic acid, acetic acid, hydrochloric acid, adipic acid, tartaric acid, fumaric acid, phosphoric acid and/or ascorbic acid in combination with lactic acid. By one approach, acid selection can be a function of the desired concentrate pH and desired taste of the diluted ready-to-drink product.

Although many acids are known to those skilled in the art of the beverage industry, many are not commonly considered for fruit flavored beverages or liquid beverage concentrates. For instance, citric, malic, tartaric, and phosphoric acids are well-known and commonly incorporated in beverage concentrates. On the contrary, some acids have never been considered in beverage concentrates due to strength unsuitability, flavor profile, and homogeneity with sweet flavors. Lactic acid, propionic acid, acetic acid, and butyric acid are used in dairy products where low or no sweetness and dairy or buttery notes are desirable. Lactic acid imparts creamy, cooked notes, while propionic acid imparts a Swiss cheese flavor profile, and butyric acid imparts a butter and aged cheese flavor profile. Acetic acid, the main acid in vinegar, imparts aroma and sourness to many food products. Butyric and propionic acids are not used in sweet fruit flavored products since they impart foreign, uncharacteristic flavors to the finished products. Similarly, based on the same assumption that dairy acids do not suit fruit flavors, lactic acid has, until now, not been considered or used when formulating liquid water enhancers.

Citric and malic acids have been predominantly incorporated in liquid water enhancing concentrates. Citric acid can be produced in commercial quantities by the fermentation of carbohydrate materials using various strains of citric acid producing fungi. Citric acid is an organic acid that occurs naturally in citrus fruit and imparts the harsh aftertaste of citrus fruits. Because it is one of the stronger edible acids, the dominant use of citric acid is as a flavoring and preservative in food and beverages, especially soft drinks and candies. Malic acid is the source of extreme tartness in United States-produced confectionery. It is also used with or in place of less sour citric acid in sour sweets. These sweets are sometimes labeled with a warning stating that excessive consumption can cause irritation of the mouth. A fermentation process may convert malic acid to much milder lactic acid. Malic acid occurs naturally in all fruits and many vegetables and is generated in fruit metabolism. In some embodiments, citric and malic acids are not the main acids in the present invention. In some embodiments, lactic acid is the dominant acid. In additional embodiments, citric acid and/or malic acid is/are incorporated in small amounts to modify flavor profiles. In further embodiments, phosphoric acid and/or tartaric acid is incorporated in the concentrate along with lactic acid to achieve various flavor profiles.

Each organic acid has a very different influence on taste when used as an acidulant. For instance, the flavor profiles of acetic and citric acid are sharp, whereas lactic acid has a mild acidic taste as well as a long-lasting flavor profile. Thus, lactic acid is useful for enhancing flavors such as tomato, green herbs, pepper, and dairy. In the inventive compositions, the use of lactic acid for fruit flavors provides an optimal balance between low pH, mild taste, and effective anti-microbial activity.

Comparing malic acid with citric acid at the same concentration, malic acid has a lower pH and a sourer taste. Malic acid has a more prolonged sour sensation and for this reason, a higher relative sourness. Each acidulant has different sensory characteristics. In some embodiments, astringency is considered when formulating a beverage concentrate. Astringency is the sensation of puckering or shrinking throughout the mouth. In the case of acidulants, the sensation of astringency occurs after the sensation of sourness and lasts longer. Lactic acid has much lower astringency than other acids and, thus, enhances true flavor perception in the mouth and may appeal to consumers who prefer a more natural and milder mouthfeel.

While malic and citric acids are hygroscopic, lactic acid is non-hygroscopic, which helps avoid moisture absorption and product degradation. Liquid lactic acid is a solution with little to no absorption of water. Liquid lactic acid allows for the formulation of all-liquid ingredient concentrates, wherein all liquids are mixed with minimal agitation or heat and then filled into containers.

The specific pH influence and sourness of an organic acid can be measured by the acid's pKa value, which is the pH at which 50% of the acid is undissociated and 50% is dissociated. Lactic acid has a lower pKa and a milder taste than citric or malic acid. Compared to citric or malic acid, when the same amount of lactic acid is used, the resulting concentrate has a higher pH, provides less tart or astringent taste, and allows for a higher incorporation rate of up to about 70% by weight of the concentrate since lactic acid does not require water for solubilization. Conversely, citric and malic acids are dry powders and require significant amounts of water for solubilization, thus limiting the incorporation rate in a specific volume.

When lactic acid is used as the main acidulant, other factors for preservation, like water activity and preservative inclusion, become negligible since lactic acid has a powerful antimicrobial property. Another advantage of using lactic acid is that, as a liquid, it enhances dispersibility in water and flowability during processing protocols. In some embodiments, lactic acid is present at about 8.0% to about 70.0% by weight of the composition. In further embodiments, lactic acid is present at about at about 10% to about 25% by weight of the composition.

With its high concentration of lactic acid, the inventive compositions can avoid adding any other edible antimicrobials or preservatives—including edible alcohols such as ethyl alcohol, propylene glycol, natural or artificial preservatives such as EDTA, sodium benzoate, potassium sorbate, sodium hexametaphosphate, nisin, natamycin, polylysine, and cultured sugars—which are present in most flavored concentrates in the market. Omitting such ingredients enhances consumer acceptance by providing clean-label beverage concentrates. In some embodiments, the inventive compositions comprise substantially no edible antimicrobial and/or substantially no additional preservative.

By “shelf stable,” it is meant that the concentrates avoid substantial flavor degradation and is microbially stable such that the concentrates have aerobic plate counts (APC) of less than about 5000 CFU/g, yeast and mold (YM) levels of less than about 500 CFU/g, and coliform (CF) levels of about 0 MPN/g for at least about six months, or about twelve months in other embodiments, when stored at ambient temperatures. In further embodiments, the concentrates are bactericidal and prevent the germination of spores. Avoiding substantial degradation of flavor means that after storage at room temperature over its shelf life, the concentrate exhibits little or no change in flavor, with little or no development of off flavor notes, when added to water to produce a beverage. The present invention limits the degradation of flavor to a minimum.

In some embodiments, the inventive concentrates comprise at least one buffer. Examples of buffers include conjugated bases and salts of an acid (e.g., sodium or potassium citrate, acetate, phosphate). In some embodiments, the buffer is an undissociated salt of an acid. In some embodiments, the buffer is potassium citrate. In some embodiments, the buffer is at an amount that achieves a concentrate pH of about 1.5 to about 3.5. The addition of buffers may allow for increased addition of acid while maintaining the desired acidity level to produce varying flavor profiles. In some embodiments, the inventive compositions comprise at least one salt buffer. In some embodiments, the at least one salt buffer is independently selected from potassium phosphate, sodium phosphate, potassium citrate, calcium citrate, sodium citrate, and combinations thereof. In some embodiments, the at least one salt buffer is potassium citrate present in an amount of about 0.2% to about 5.0% by weight of the composition. In some embodiments, the salt buffer is sodium citrate present at about 4.0% to about 22.0% by weight of the composition.

Another aspect of the present invention provides methods for producing liquid flavored concentrates. Because lactic acid is a flowable liquid, it is possible to use simple blending and mixing techniques and vessels to prepare concentrates with all liquid ingredients. No dry or solid ingredients are incorporated, as ingredients are selected from a group of liquid components. Water, liquid flavor, lactic acid, and optional ingredients are mixable and miscible without the need to dissolve any dry component, which allows for the simple preparation of liquid flavored concentrates. In contrast, commercial products use various dry ingredients since citric acid, sorbate, and coloring agents are in a solid state, which must be solubilized to get their full functionality and require specific mixing vessels, heating protocol, and longer preparation time. The inventive methods' simple and quick mixing of liquid components, with or without heating, produce economical yet stable concentrates with excellent shelf life qualities. In some embodiments, liquid lactic acid is incorporated into an all-liquid mixture at about 15% to about 70% by weight of the composition.

Additional aspects of the present invention include ultra-concentrated beverage liquids with lower dosing requirements than existing products in the market and methods for preparing the same. Because lactic acid is liquid, it does not require water for solubilization, thereby leaving free water available to solubilize any dry ingredients. Previously, when citric acid or phosphoric acid was used as the acidulant, acid percentage in the concentrate was limited by the amount of free water available, thus reducing the maximum amount of acid that could be incorporated. In the present invention, acid concentrations may reach about 70% of the concentrate when lactic acid is used alone or in combination with low levels of one or more other acid(s) such as phosphoric acid, citric acid and/or malic acid. When coupled with concentrated flavorings, coloring agents and sweeteners, a surprisingly low dosing concentrate with high flavor impact is produced. Cold filling into containers is feasible without the risk of spoilage because of the high concentration of lactic acid.

In some embodiments, a serving size of about 0.4 to 1.0 ml of an inventive composition is added to about 8 to 16 oz. of water to produce a pleasant tasting final beverage. The inventive compositions may be used with dosing systems like vending and dispensing machines to add an extra dose of flavor or nutritional boost to beverages. Moreover, the ultra-concentrated liquid may be filled into smaller dispensing portable packages or double the number of servings of an ordinary container in the market. For example, current liquid water enhancer concentrates in the market are filled into about 48 ml squeeze bottles with a silicone valve to deliver about 24 servings of about 2 ml each. When an ultra-concentrate of the present invention is filled into the same 48 ml container, the number of servings can increase, for example, up to about 48 servings of 1 ml each. Thus, the inventive compositions can provide economic value to both consumers and manufacturers.

Liquid lactic acid reduces the need for water inclusion which in turn reduces the water activity of the concentrates, thus providing better microbial resistance and flavor stability. Additionally, reducing the water activity or amount of free water allows for incorporation of higher levels of other beneficial nutrients like electrolytes to produce thirst quenching products. Inasmuch as the use of liquid lactic acid eliminates the need for any water inclusion in the formulations, low water activity concentrates with water activity value of about 0.1 may be produced. Compositions with various water activities values, ranging from about 0.10 to 0.95, can be produced by varying the amounts of water and lactic acid added. The present invention is the first to elucidate how to formulate flavored concentrates with a water activity of about 0.50 or less. Moreover, the inventive compositions are the only flowable beverage concentrates produced with undetectable water activity and characterized by acidic, sweet, and fruity attributes.

The present invention may employ a humectant to produce concentrates with an extremely low water activity of about 0.50 or less. In some embodiments, about 50% glycerin is used along with lactic acid to produce a concentrate of about 0.20 water activity. Varying the amount of humectant may produce different water activity levels. A humectant is a hygroscopic substance with an affinity to form hydrogen bonds with molecules of water. It is often a molecule with several hydrophilic groups, most often hydroxyl groups, but amine and carboxyl groups, sometimes esterified, may be included as well. Since hygroscopic substances absorb water from the air, they are frequently used in desiccation. When used as a food additive, the humectant has the effect of keeping the foodstuff moist. Humectants reduce the water activity of liquid.

Water activity or A_{w} is a measurement of the energy status of the water in a system. It is defined as the vapor pressure of water divided by that of pure water at the same temperature; therefore, pure distilled water has a water activity of exactly one. There are several factors that control water activity in a system: colligative effects of dissolved species (e.g., salt or sugar) interacting with water through dipole-dipole, ionic, and hydrogen bonds; capillary effect where the vapor pressure of water above a curved liquid meniscus is less than that of pure water because of changes in the hydrogen bonding between water molecules; surface interactions in which water interacts directly with chemical groups on undissolved ingredients (e.g., starches and proteins) through dipole-dipole forces, ionic bonds (H₃O+ or OH−), van der Waals forces (hydrophobic bonds), and hydrogen bonds. It is the combination of these three factors in a food product that reduces the energy of the water and, thus, reduces the relative humidity as compared to pure water.

Water activity is also temperature dependent. Temperature changes water activity due to changes in water binding, dissociation of water, solubility of solutes in water, and/or state of the sample matrix.

If a dry powder acid like citric, malic, or phosphoric acid is added to glycerin, it will precipitate out and form a layer at the bottom of the container due to lack of sufficient water to dissolve it. The higher the amount of acid, the higher the amount of water needed and the lower the amount of humectant that could be present. A surprising finding of the present invention is that any amount of lactic acid could be mixed with any amount of a humectant (such as glycerin, maltitol and/or other liquid sugar alcohols) without precipitating out, thus impacting the sourness in the final diluted beverage. Lactic acid with various levels of water (from about 10% to about 88% by weight) could be utilized in the concentrate when low water activity is not desired. When concentrates with no added water are formulated, all the water content may come exclusively from lactic acid. Therefore, the lowest naturally available water content of lactic acid could be utilized. In some embodiments, lactic acid at about 90% w/w concentration could be used, providing about 18% by weight water content in the resulting concentrate. When dry ingredients (like sweeteners and coloring agents) are added, water activity is reduced. Mixing about 50% glycerin with about 40% lactic acid reduces the water activity to about 0.30 or less while providing sufficient water to dissolve artificial sweeteners yet providing low pH in the concentrate and a high degree of sour notes in the final diluted beverage.

The inventive concentrates can optionally include coloring agents (artificial and/or natural), flavorings (artificial and/or natural), sweeteners (artificial and/or natural), caffeine, electrolytes (including salts), nutrients (e.g., vitamins and minerals), and the like. Preservatives, such as sorbate or benzoate, can be included if desired but are generally unnecessary for shelf stability. The present compositions and methods can optionally contain or use various additional ingredients suitable for rendering products more organoleptically acceptable, more nutritious, and/or more storage stable. Such optional ingredients may include lipids, coloring agents, preservatives, acids, pH modifiers (acidic or alkaline), and mixtures thereof. The concentrates can contain any combination of the additives or ingredients described herein, such as water, flavorings, nutrients, coloring agents, sweeteners, salts, buffers, gums, caffeine, stabilizers, and the like. Optional preservatives, such as sorbate or benzoate, can be included but are not required to maintain shelf stability. For example, ascorbic acid in an amount from about 0.5% to about 20.0% by weight based on the weight of concentrate may be incorporated to provide a nutritional beverage concentrate with a high vitamin C content ranging from about 10 mg to about 400 mg per 2 ml serving. If ascorbic acid is included, a buffer could also be added to raise the pH up to about 3.0 to about 3.5 to preserve the flavor and color integrity throughout the concentrate's shelf life.

Other optional ingredients, such as flavorings, can be included in the inventive concentrates. Examples of flavorings include without limitation fruits, teas, coffees, and the like, and combinations thereof. The flavorings can be provided in various types and forms, including alcohol-containing flavorings (such as ethanol- or propylene glycol-containing flavorings), flavor emulsions, extruded flavorings, liquid flavorings, and spray-dried flavorings. A variety of commercially available flavorings can be used. The flavoring(s) can be included at about 1% to about 30% or, in other embodiments, about 2% to about 20%, by weight of the beverage concentrates. The precise amount of flavoring(s) included in a concentrate will vary depending on the concentration of the concentrate itself, the concentration of the flavor key(s) in the flavoring(s), and the desired flavor profile of the resulting beverage. Generally, extruded and spray-dried flavorings can be included in lower amounts than alcohol-containing flavorings and flavor emulsions because the extruded and spray-dried flavorings often include higher percentages of flavor keys.

In some embodiments, the inventive composition further comprises a sweetener. Useful sweeteners may include, for example, honey, agave syrup, sugar, erythritol, sucralose, aspartame, stevia, saccharine, monatin, luo han guo (monk fruit), neotame, sucrose, Rebaudioside A (often referred to as “Reb A”), fructose, cyclamates (such as sodium cyclamate), acesulfame potassium, other nutritive or non-nutritive sweeteners, and combinations thereof. In some embodiments, an artificial sweetener is present at about 0.3% to about 5.0% by weight of the concentrate. In some embodiments, the artificial sweetener is present at about 0.5% to about 2.5% by weight of the concentrate. In some embodiments, a natural sweetener is present at about 30.0% to about 60% by weight of the concentrate. In some embodiments, the sweetener is agave syrup and is present at about 30% to about 65% by weight of the concentrate.

The containers suitable for filling with the inventive liquid concentrates include thermoformed packages, squeeze bottles with silicone valves or dispensing caps, droppers, pumps, dispensing machines known in the art, and the like. In some embodiments, the liquid concentrates are suitable for cold filling while maintaining shelf stability for at least about six months and, in further embodiments, for at least about twelve months at ambient temperatures.

The present invention also provides kits comprising the flavored beverage concentrate compositions. In some embodiments, a kit comprises a beverage concentrate composition made using lactic acid and a container, as disclosed herein. The multipurpose kit offers portability and shelf stability.

### Methods of Preparation

The present invention further provides methods of preparing flavored beverage concentrate compositions in various flavors, wherein the compositions are shelf-stable at ambient temperature.

The flavored beverage concentrate compositions can be prepared, for example, in a batch or a continuous mixing device. The batch mixers of any type can be used. In some embodiments, a continuous mixer is employed. Pasteurization (if desired) and cooling steps could be performed in batch processing or continuous high temperature short time (HTST) equipment.

In some embodiments, the method comprises mixing about 8.0% to about 70.0% acid, about 1.0% to about 12.0% buffer, about 1.0% to about 30.0% flavoring, and about 30% to about 80% water to produce a flavored beverage concentrate having a pH of about 1.0 to about 3.5 and, in further embodiments, a pH of about 0.7 to about 2.6. In additional embodiments, the method further comprises packaging the concentrate in an airtight container with or without pasteurization.

Any combination of the ingredients and components as described herein may be employed in preparing the flavored concentrate compositions. The above-described compositions may be manufactured in any manner known to those skilled in the art. In some embodiments, the method comprises first adding lactic acid to deionized water at about 65° to about 75° F. and then adding flavoring(s), coloring agent(s) and/or sweetener(s). In additional embodiments, the method further comprises mixing the lactic acid, water, and flavoring(s), coloring agent(s) and/or sweetener(s) for about fifteen minutes. In yet additional embodiments, the method further comprises heating the lactic acid, water, and flavoring(s), coloring agent(s) and/or sweetener(s) to a temperature of about 155° to about 210° F. for about 5 to about 20 minutes.

In some embodiments, the method produces in one batch about 1,000 pounds of the shelf-stable liquid flavored concentrate composition. In further embodiments, the method produces a composition comprising about 40% to about 80% by weight water, about 8.0% to about 22% by weight lactic acid, and about 2.0% to about 30% sweetener.

Another aspect of the invention provides methods for preparing an all-liquid (no solids are added) flavored concentrate composition, comprising mixing about 50% to about 80% liquid lactic acid with about 0.5% to about 1.0% liquid flavoring(s), about 1.0% to about 3% high intensity sweetener syrup, and about 10.0% to about 30.0% glycerin as a humectant.

In some embodiments, the methods can produce in one batch about 22,000 pounds of shelf-stable flavored concentrate composition. In further embodiments, the methods can produce a composition comprising about 70% to about 80% by weight water, about 15% to about 27% by weight lactic acid, and about 0.5% to about 2.5% by weight high intensity sweetener.

In further embodiments, the methods further comprise dispensing the flavored concentrate composition in small single serving packages pre-measured for use with standard 12 or 16-ounce water bottles. The packages may be of any shape, form or size.

### EXAMPLES

This invention is further illustrated by the following examples, which are to be regarded as illustrative only, and in no way limit the scope of the invention. The following non-limiting examples and data illustrate various aspects and features relating to the method(s) and products/compositions of this invention, including the surprising and unexpected modification of, control of, and/or improvements in water activity level, homogenization, emulsion formation, solubility of actives, and/or improvement of energy level and mood elevation.

### Example 1

The pH, taste, and mouthfeel of lactic, citric, and malic acids are compared. With each acid, 22 g of the acid is mixed in 78 ml of water, then 2 ml of the mixture is diluted in 250 ml of water, and pH readings of the diluted solutions are obtained. The lactic acid solution has the highest pH value and the most pleasant taste and mouthfeel with the least sour notes and astringency left in the mouth.

| | Lactic | Citric | Malic |
|---|---|---|---|
| | Acid | Acid | Acid |
| Acid (% by weight) | 22 | 22 | 22 |
| Water (% by weight) | 78 | 78 | 78 |
| Total (% by weight) | 100 | 100 | 100 |
| pH | 1.45 | 1.15 | 1.33 |

### Example 2

The impact of adding a buffer to solutions of lactic, citric, and malic acid is examined With each acid, 22 g of the acid is mixed with 2 g of sodium citrate in 76 ml of water, and pH readings of the resulting concentrates are obtained. Then 2 ml of each concentrate is diluted in 250 ml of water, and the resulting solutions are evaluated for taste and mouthfeel.

| | Lactic | Citric | Malic |
|---|---|---|---|
| | Acid | Acid | Acid |
| Acid (% by weight) | 22 | 22 | 22 |
| Water (% by weight) | 76 | 76 | 76 |
| Sodium Citrate (% by weight) | 2 | 2 | 2 |
| Total (%) | 100 | 100 | 100 |
| pH | 2.49 | 2.02 | 2.12 |

The lactic acid solution has the highest pH and the most pleasant taste and mouthfeel with the least sour notes and astringency left in the mouth. The delta pH, when compared to concentrates without buffer shown in Example 1, is 0.79 for the malic acid solution, 0.87 for the citric acid solution, and 1.04 for the lactic acid solution. The data indicate that lactic acid's buffering capacity is lower than that of the other two acids and, hence, may need lower amounts of buffer to achieve the same pH value as the other two acids in the presence of buffers.

### Example 3

The following compositions are formulated by first heating deionized water to 75°-80° F. Lactic acid and an intensive sweetener are added simultaneously to the heated water and mixed for five minutes. While maintaining the temperature of the mixture at 75°−80° F., a liquid flavoring, fruit juice concentrate, and natural coloring agent are added and mixed for five minutes. The mixture is heated to between 190° F. and 215° F. After cooling to 70° F., the resulting flavored concentrate is packaged.

| | A | B | C | D |
|---|---|---|---|---|
| Lactic Acid (% by weight) | 8.00 | 16.00 | 24.00 | 32.00 |
| Sucralose (% by weight) | 2.20 | 2.20 | 2.50 | 2.50 |
| Natural Red Coloring Agent | — | 2.00 | 2.00 | 2.00 |
| (% by weight) | | | | |
| Natural Fruit Punch Flavoring | 2.00 | 2.00 | 3.00 | 3.00 |
| (% by weight) | | | | |
| Water (% by weight) | 87.80 | 77.80 | 68.50 | 60.50 |
| Total (% by weight) | 100.00 | 100.00 | 100.00 | 100.00 |
| Concentrate pH | 1.7 | 1.67 | 1.55 | 1.45 |

Each concentrate is diluted in water at the ratio of 1:120 concentrate to water (one part concentrate added to 120 parts water). All diluted concentrates of A, B, C, and D exhibit desirable taste, color, and flavor. All pH values are in an acceptable range to provide protection against spoilage and pathogenic microorganisms. Even at the highest addition level, lactic acid is found to accentuate the fruit flavor profile with a pleasant acidic note void of astringency and aftertaste. The data surprisingly indicate that the amount of lactic acid could be quadrupled without deteriorating the taste of the concentrate, which is unexpected when other acids are used.

### Example 4

The following compositions are formulated by first heating deionized water to 75°-80° F. Lactic, citric, and malic acids and sweetener are added to the heated water and mixed for five minutes. While maintaining the temperature of the mixture at 90°−100° F., flavoring and coloring agent are added. The mixture is mixed for twenty minutes. The resulting flavored concentrate is then cold filled into containers.

| | E | F | G |
|---|---|---|---|
| Lactic Acid (% by weight) | 15.00 | 15.00 | 22.00 |
| Sucralose (% by weight) | 2.50 | 2.50 | 2.50 |
| Citric Acid (% by weight) | 6.00 | — | 2.00 |
| Malic Acid (% by weight) | — | 6.00 | 2.00 |
| Red Dye 40 (% by weight) | 0.10 | 0.10 | 0.20 |
| Artificial Fruit Punch Flavoring | 2.50 | 2.50 | 5.00 |
| (% by weight) | | | |
| Water (% by weight) | 73.90 | 73.90 | 66.30 |
| Total (% by weight) | 100.00 | 100.00 | 100.00 |
| Concentrate pH | 1.45 | 1.47 | 1.41 |

Each concentrate is diluted in water at the ratio of 1:120 concentrate to water (one part concentrate added to 120 parts water). All diluted concentrates of E, F, and G exhibit desirable taste, color, and flavor. All pH values are in an acceptable range to provide protection against spoilage and pathogenic microorganisms. Lactic acid as a dominant acid, with smaller amounts of citric acid and malic acid, accentuates the fruit flavor profile with a pleasant acidic note void of astringency and aftertaste.

### Example 5

An ultra-concentrated, flavored composition is prepared by first placing deionized water into a mixing vessel. Lactic acid, citric acid, flavoring, coloring agent, trisodium citrate, and sweetener are added to the water and mixed for five minutes. The mixture is heated to and maintained at 175-190° F. for twenty minutes. The mixture is cooled to ambient temperature. The flavored concentrate is filled into containers with pumps to be pumped into various beverages as a booster or mixed with water to provide finished beverages.

| | H | I | J | K |
|---|---|---|---|---|
| Lactic Acid (% by weight) | 40.00 | 40.00 | 40.00 | 65.00 |
| Citric Acid (% by weight) | 23.00 | 23.00 | 23.00 | 8.00 |
| Sucralose (% by weight) | 5.00 | 5.00 | 5.00 | 5.00 |
| Trisodium Citrate (% by weight) | — | 5.00 | 12.00 | — |
| Red Dye 40 (% by weight) | 0.20 | 0.20 | 0.20 | 0.20 |
| Artificial Fruit Punch Flavoring | 5.00 | 5.00 | 5.00 | 5.00 |
| (% by weight) | | | | |
| Water (% by weight) | 26.80 | 21.80 | 14.80 | 16.80 |
| Total (% by weight) | 100.00 | 100.00 | 100.00 | 100.00 |
| Concentrate pH | 1.61 | 2.02 | 2.47 | 1.23 |

Each ultra-concentrate is diluted in water at the ratio of 1:240 concentrate to water (one part concentrate added to 240 parts water). All diluted concentrates of H, I, J and K exhibit desirable taste, color, and flavor. The use of liquid lactic acid allows for high levels of citric acid to be incorporated, even with a minimal amount of water present, which would have been impossible to achieve without the liquidity and flowability of lactic acid as a carrier medium. When each ultra-concentrate is diluted in water at the ratio of 1:480 (one part concentrate added to 480 parts water), similarly pleasant taste, color, and flavor are obtained. To counter any damaging impact of the concentrates' high acid concentration on their natural flavoring(s) and coloring agent(s), artificial flavoring(s) and synthetic coloring agent(s) may be used to improve stability over extended shelf life. Citric acid may be substituted with ascorbic acid to achieve a high level of vitamin C as well as pleasant acidic notes and flavor profile in the finished beverage.

### Example 6

An all-liquid ingredient shelf-stable concentrate is prepared. The liquid ingredients are added into a vessel and mixed with a hand mixer for five minutes. Without any further mixing or heating, the resulting concentrate is ready to be filled into containers.

| | L | M |
|---|---|---|
| Lactic Acid (% by weight) | 20.00 | 27.00 |
| Agave Syrup (% by weight) | 34.00 | 35.00 |
| Strawberry Juice Concentrate | 5.00 | 5.00 |
| (% by weight) | | |
| Natural Strawberry Flavoring | 2.50 | 3.50 |
| (% by weight) | | |
| Water (% by weight) | 38.50 | 29.50 |
| Total (% by weight) | 100.00 | 100.00 |

Upon dilution in water at various mixing ratios, the diluted concentrates exhibit organoleptic characteristics like those of other beverages made from concentrates prepared utilizing conventional manufacturing processes.

### Example 7

Low water activity compositions are formulated with mostly liquid ingredients except for sucralose and trisodium citrate. All ingredients are blended at no specific order at ambient temperature. After mixing for 20 minutes, the resulting concentrate is packaged in squeeze bottles or bottles with dispensing pumps.

| | O | P | Q | R | S |
|---|---|---|---|---|---|
| Liquid Lactic Acid | 42.00 | 70.00 | 86.00 | 90.00 | 65.00 |
| (% by weight) | | | | | |
| Sucralose (% by weight) | 3.00 | 4.00 | 4.00 | 4.00 | 7.00 |
| Trisodium Citrate | — | — | 4.00 | — | — |
| (% by weight) | | | | | |
| Liquid Shade Red | 1.00 | 1.00 | 1.00 | 1.00 | 1.00 |
| Coloring Agent | | | | | |
| (% by weight) | | | | | |
| Liquid Fruit Punch | 3.00 | 5.00 | 5.00 | 5.00 | 27.00 |
| Flavoring (% by weight) | | | | | |
| Glycerin (% by weight) | 51.00 | 20.00 | — | — | — |
| Total (% by weight) | 100.00 | 100.00 | 100.00 | 100.00 | 100.00 |
| Water Content | 5.04 | 8.40 | 10.32 | 10.80 | 7.80 |
| Concentrate Water | 0.21 | 0.41 | 0.48 | 0.49 | 0.32 |
| Activity | | | | | |
| Concentrate pH | 1.54 | 0.69 | 2.04 | 1.01 | 1.34 |

In most compositions, lactic acid is the major ingredient. In formula 0, a high amount of glycerin is added to produce a flowable, liquid concentrate with a low water activity of about 0.21. While no water beyond the water in the ingredients themselves is added, the glycerin and lactic acid help maintain the liquidity and flowability of the compositions. Composition 0 has a significantly reduced water activity of 0.21, which is close to being undetectable while providing flavor stability and microbiological properties that, until the present invention, was achievable in only dry and powdered compositions void of any water content.

It is surprising to discover that dry sucralose and sodium citrates dissolve in the zero-added water compositions. The liquid lactic acid has a concentration of about 88% by weight lactic acid and about 12% water. It is plausible that the water content of lactic acid is responsible for dissolving the small amount of dry ingredients. However, if more solids such as dry acids are used, precipitation may occur, thereby rendering the resulting concentrates unusable and unprocessable. Coloring agents and flavorings are usually produced in water-free or low-water content bases, so they do not contribute much moisture to the finished concentrates.

In composition S, glycerin is omitted, and a flavoring is included at a high level of 27% by weight. Sucralose is increased to balance out the impact of high levels of flavoring and lactic acid on taste perception. Natural and artificial flavorings may provide diluents and carriers that can impact water activity to varying degrees. Flavorings having various water, solvent, and humectant contents may also contribute water for dissolving solids in the concentrates or for raising the water content in the concentrates.

Upon dilution in water, all concentrates exhibit excellent appearance, taste, and flavor profiles at very low dosing. To evaluate organoleptic properties, about 0.20 ml to about 0.3 ml of each concentrate is mixed in about 8 ounces of water. Dosing parameters can be adjusted to achieve various flavor, acidity, and sweetness intensities in the final beverage.

It will be apparent to those skilled in the art that the disclosed subject matter may be directed to one or more of the above- and below-indicated embodiments in any combination, and changes may be made, and equivalents may be substituted without departing from the spirit and scope of the invention. Hence, the description and examples should not be construed as limiting the scope of the invention. All references, publications, patents, and patent applications disclosed herein are hereby incorporated by reference in their entirety as if each had been individually incorporated.

What is claimed is:

1. A shelf-stable liquid flavored beverage concentrate composition comprising:
a flavoring;
lactic acid at about 8% to about 90% by weight of the composition; and
water at about 0% to about 88% by weight of the composition.

2. The shelf-stable liquid flavored beverage concentrate composition according to claim 1, wherein the flavoring constitutes from about 1% to about 30% by weight of the composition.

3. The shelf-stable liquid flavored beverage concentrate composition according to claim 1, wherein water constitutes about 10% to about 90% by weight of the lactic acid.

4. The shelf-stable liquid flavored beverage concentrate composition according to claim 1, wherein the water constitutes total water content of the composition.

5. The shelf-stable liquid flavored beverage concentrate composition according to claim 1, further comprising citric acid in an amount from about 23.0% to about 26.0% by weight of the composition.

6. The shelf-stable liquid flavored beverage concentrate composition according to claim 1, further comprising malic acid in an amount from about 23.0% to about 26.0% by weight of the composition.

7. The shelf-stable liquid flavored beverage concentrate composition according to claim 1, further comprising ascorbic acid in an amount from about 0.5% to about 23.0% by weight of the composition.

8. The shelf-stable liquid flavored beverage concentrate composition according to claim 7, further comprising phosphoric acid in an amount from about 23.0% to about 26.0% by weight of the composition.

9. The shelf-stable liquid flavored beverage concentrate composition according to claim 1, further comprising a buffer in an amount from about 2.0% to about 12.0% by weight of the composition.

10. The shelf-stable liquid flavored beverage concentrate composition according to claim 9, wherein the buffer comprises one or more components independently selected from potassium phosphate, sodium phosphate, potassium citrate, calcium citrate, and sodium citrate.

11. The shelf-stable liquid flavored beverage concentrate composition according to claim 1, wherein the composition comprises substantially no edible antimicrobial or additional preservative.

12. The shelf-stable liquid flavored beverage concentrate composition according to claim 1, wherein the composition has a water activity of about 0.50 or less.

13. The shelf-stable liquid flavored beverage concentrate composition according to claim 1, wherein the composition has a water activity of about 0.30 or less.

14. A shelf-stable liquid flavored beverage concentrate composition comprising:
a liquid flavoring;
liquid lactic acid at about 60% to about 90% by weight of the composition; and
a liquid humectant at about 20% to about 50% by weight of the composition;
wherein all components of the composition are liquid.

15. The shelf-stable liquid flavored beverage concentrate composition according to claim 14, wherein the composition comprises substantially no edible antimicrobial or additional preservative.

16. The shelf-stable liquid flavored beverage concentrate composition according to claim 14, wherein the composition has a water activity of about 0.50 or less.

17. A shelf-stable liquid flavored beverage concentrate composition comprising:
a liquid flavoring at about 2% to about 20% by weight of the composition;
liquid lactic acid at about 80% to about 90% by weight of the composition;
a non-nutritive sweetener at about 4-8% by weight of the composition; and
a liquid coloring agent at about 1% to about 2% by weight of the composition.

18. The shelf-stable liquid flavored beverage concentrate composition according to claim 17, wherein the composition comprises substantially no edible antimicrobial or additional preservative.

19. The shelf-stable liquid flavored beverage concentrate composition according to claim 17, wherein the composition has a water activity of about 0.50 or less.

20. A beverage package kit comprising the shelf-stable liquid flavored beverage concentrate composition of claim 1, and a container suitable for delivering the shelf-stable liquid flavored beverage concentrate composition.
